(19) United States
(12) Patent Application Publication
(10) Pub. No.: US 2022/0011141 A1
(43) Pub. Date: Jan. 13, 2022

(54) Linear guide comprising a length measuring device

(71) Applicant: Schaeffler Technologies AG & Co. KG, Herzogenaurach (DE)

(72) Inventors: Dietmar Rudy, Kleinbundenbach (DE); Patrick Daniel, Kirkel (DE); Thomas Elicker, Breitenbach (DE)

(21) Appl. No.: 17/292,648

(22) PCT Filed: Oct. 16, 2019
(86) PCT No.: PCT/DE2019/100893

§ 371 Date: May 10, 2021

(30) Foreign Application Priority Data
Nov. 9, 2018 (DE) 10 2018 128 023.8

(51) Int. Cl. G01D 5/54

(52) U.S. Cl. CPC G01D 5/54

(57) ABSTRACT

A linear guide includes a guide carriage (1) arranged on a guide rail (2) so as to be longitudinally displaceable, and comprising a length measuring device (5) provided on the guide rail (2) for determining a position of the guide carriage (1), which length measuring device has two measuring heads (6) and two tracks (7, 8) arranged side-by-side on the guide rail (2), each of which tracks is assigned to one of the measuring heads (6). Each of said tracks (7, 8) has a plurality of dimensional measures (9, 14) arranged one behind the other along the track (7, 8), wherein in an overlapping region (x1, yn, z1), the dimensional measures (9, 14) of both tracks (7, 8) overlap each other.

### CROSS-REFERENCE TO RELATED APPLICATIONS

This application is the U.S. National Phase of PCT Appin. No. PCT/DE2019/100893 filed Oct. 16, 2019, which claims priority to DE 10 2018 128 023.8 filed Nov. 9, 2018, the entire disclosures of which are incorporated by reference herein.

The present disclosure relates to a linear guide having a length measuring device, having a guide carriage arranged so as to be longitudinally displaceable on a guide rail.

### BACKGROUND

A linear guide according to the features of the preamble of claim 1 has been made known from EP2034201 B1. This linear guide is provided with a length measuring device provided for determining a position of the guide carriage on the guide rail, which length measuring device has two measuring heads and two tracks arranged side-by-side on the guide rail, each of which is assigned to one of the measuring heads. Dimensional measures made from belts are attached to the guide rail. In the case of magnetically coded dimensional measures, the length of the belts is limited by the size of the available magnetization systems and the limitation of the symbols that can be displayed.

An object of the present disclosure is to provide a linear guide, which facilitates a length measuring device that works reliably and is inexpensive to manufacture.

This linear guide is provided with a guide carriage arranged so as to be longitudinally displaceable on a guide rail, and with a length measuring device provided for determining a position of the guide carriage on the guide rail. Two measuring heads are provided that can be moved with the guide carriage along with two tracks arranged side-by-side on the guide rail, each of which is assigned to one of the measuring heads. According to the present disclosure, the tracks are each provided with a multiplicity of dimensional measures arranged one behind the other along the track. The dimensional measures arranged on both tracks overlap one another in an overlapping region.

An advantage of the present disclosure can be seen in the fact that short belt pieces, for example made of steel, can be used as the dimensional measure, which easily bear an incremental or an absolute coding, or also a unique identifier, as will be explained further below. A dimensional measure of one track overlaps a dimensional measure of the other track. The measuring heads are arranged in such a way that when the guide rail is passed over, one of the two measuring heads always receives a signal, either via the dimensional measure of one track or via the dimensional measure of the other track.

This means that the dimensional measures of both tracks can be arranged in a gap, i.e., with an axial distance from one another. The gap in one track is bridged by the dimensional measure of the adjacent track.

The dimensional measures bear position symbols that can be coded absolutely or incrementally. For example, position symbols can be provided in the form of a division in mm distances, or a binary representation of absolute position symbols.

Expediently, the overlapping region s is larger than a signal detection width b of the measuring heads. As soon as one measuring head on one track no longer detects a signal, a signal detection by the other measuring head on the other track is ensured.

The measuring heads can be arranged at the same height in the direction of the rail axis, or also axially offset from one another by an axial offset v, which will be discussed in detail below.

An expedient further development provides that the dimensional measures each have a unique identifier, which is different from the identifiers of the other dimensional measures. As soon as a measuring head comes into the detection range of such a dimensional measure, the identifier can be used to determine on which dimensional measure the measuring head is located.

In addition to the read-out—for example, incremental—position symbols, an exact position determination can thus take place.

An expedient further development provides that each overlapping region is different in size from all other overlapping regions. In this case, the unique identifiers in both tracks can be omitted: the two measuring heads drive over the overlapping regions and detect the axial extent thereof, which is unique along the guide rail. If the arrangement of the overlapping regions along the guide rail is fixed, it can consequently be detected by driving over an overlapping region at which dimensional measure the measuring head is straight.

If the dimensional measures of a track are arranged at an axial distance from one another, an expedient further development provides for filler pieces to be inserted between dimensional measures arranged side-by-side. These filler pieces can then ensure a uniform contour of the track, without gaps and edges.

In a known manner, the guide carriage carries the measuring heads and surrounds the guide rail with two legs, the guide rail being provided with the two tracks on at least one of the two longitudinal sides thereof. For reasons of space, however, it can be useful, in particular with small cross-sections of guide rails, to arrange one track on one longitudinal side and the other track on the other longitudinal side.

### BRIEF SUMMARY OF THE DRAWINGS

The present disclosure is explained in more detail below with reference to several exemplary embodiments shown in the figures. In the drawings:

FIG. 1 shows a view of a first linear guide,

FIG. 2 shows a cross-section through the linear guide from FIG. 1,

FIG. 3 shows a view of a further linear guide,

FIG. 4 shows a cross-section through the linear guide from FIG. 3,

FIG. 5 shows a first embodiment of a length measuring device based on a linear guide according to FIG. 1,

FIG. 6 shows a section from FIG. 5 with schematically indicated tracks of the length measuring device,

FIG. 7 shows a second embodiment of a length measuring device based on a linear guide according to FIG. 1,

FIG. 8 shows a section from FIG. 7 with schematically indicated tracks of the length measuring device,

FIG. 9 shows a third embodiment of a length measuring device based on a linear guide according to FIG. 3,

FIG. 10 shows a section from FIG. 9 with schematically indicated tracks of the length measuring device,

FIG. 11 shows a fourth embodiment of a length measuring device based on a linear guide according to FIG. 3,

FIG. 12 shows a section from FIG. 11 with schematically indicated tracks of the length measuring device,

FIG. 13 shows a table describing the determination of the position of the guide carriage, and

FIG. 14 shows an exemplary embodiment to which the table in FIG. 13 relates.

### DETAILED DESCRIPTION

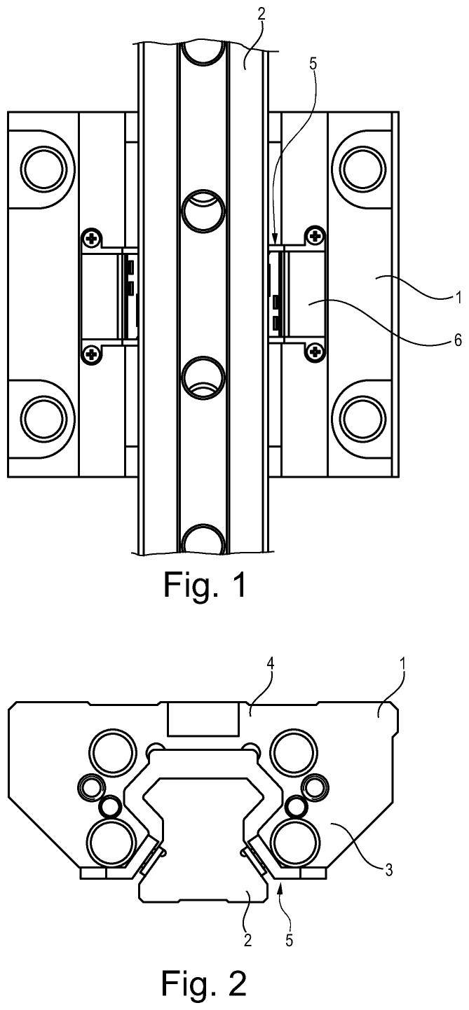

FIGS. 1 and 2 show a linear guide with a first type of measuring head arrangement. A guide carriage 1 is arranged on a guide rail 2 so as to be longitudinally displaceable. The exemplary embodiment has a four-row recirculating roller bearing with rolling element return. The guide carriage 1 engages around the guide rail 2 with two legs 3, the one ends of which are connected to one another by a back 4.

A length measuring device 5 is provided, of which two measuring heads 6 can clearly be seen in FIGS. 1 and 2, each of which is arranged on one of the legs 3.

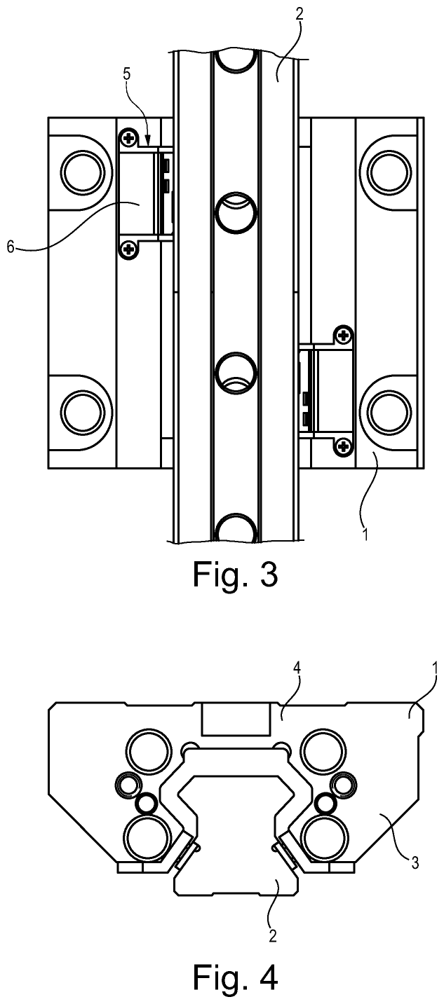

FIGS. 3 and 4 show a linear guide with a second type of measuring head arrangement which only differs from the above-mentioned arrangement in that the two measuring heads 6 are arranged to be axially offset by an amount delta.

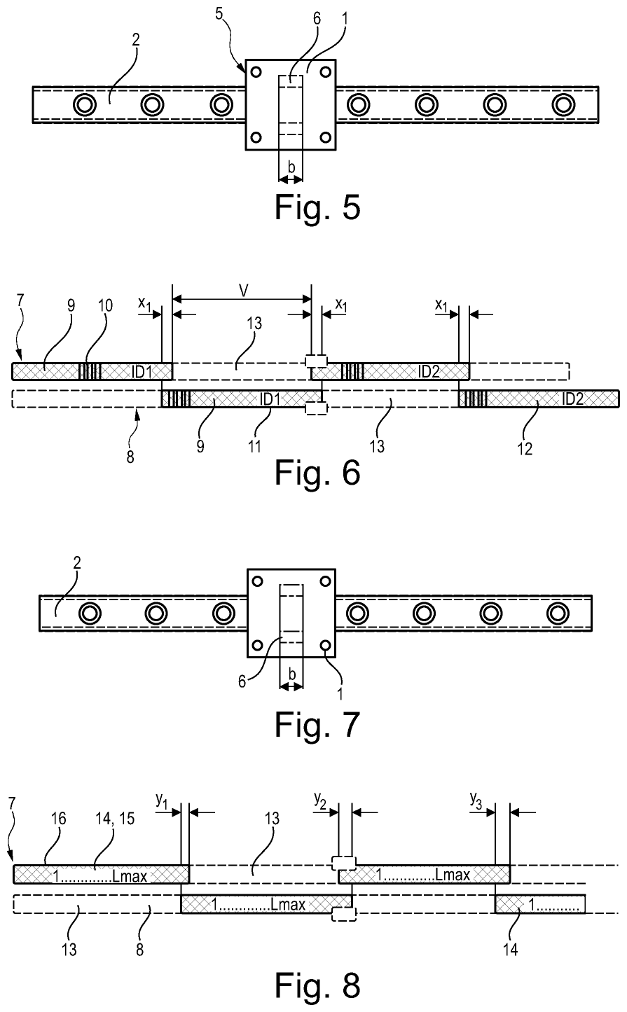

FIGS. 5 and 6 show a first embodiment of a length measuring device 5. The guide carriage 1 can be seen schematically with the two measuring heads 6 mounted at the same axial height and having a signal detection width b.

On both longitudinal sides of the guide rail 2 facing away from one another there is a track 7, 8 with dimensional measures 9 arranged axially one behind the other. Each dimensional measure 9 has a scale, which is indicated in the exemplary embodiment by a line sequence. Here, for example, a numerical sequence of digits, for example, such as 1, 2, 3, 4, can be formed, which indicate a position on the dimensional measure 9. Such scales form position symbols 10.

Each dimensional measure 9 also has a unique identifier 11. A measuring head 6, which is located in the detection region of a dimensional measure 9, receives a signal with this identifier 11. In this way it can be determined on which of the dimensional measures 9, arranged one behind the other, the measuring head 6 in question is located.

In all of the exemplary embodiments described, the dimensional measures 9 are formed on both tracks 7, 8 from belt pieces 12 which are fastened to the guide rail 2.

In this exemplary embodiment, this plurality of belt pieces 12 is arranged one behind the other with an axial offset v. The axial offset v is smaller than the length of a belt piece 12. The gap created by the offset v is filled by filler pieces 13 so that the track 7, 8 has a uniform closed cross-section over the axial extension thereof.

In both tracks 7, 8, the belt pieces 12 are offset from one another in such a way that a belt piece 12 of one track 7, 8 overlaps the axial offset v of the other track and the two belt pieces 12 of the other track 7, 8 axially overlap by an overlapping region x1 that limit this axial offset v. The overlapping region x1 is larger than the signal detection width b of the measuring head 6.

When the measuring heads 6 scan the two tracks 7, 8 of the guide rail 2, one of the two measuring heads 6 always receives information with the identifier 11 of the belt piece 12 that has been driven over. The overlapping region x1 ensures that at least one of the two measuring heads can read in one of the identifiers 11. In the overlapping region, both measuring heads 6 receive the respective identifier 11 of the belt piece 12 that has been driven over.

The sequence of the dimensional measures 9 together with the information provided by the position symbols 10 consequently enables the position of the guide carriage 1 on the guide rail 2 to be clearly determined.

The exemplary embodiment shown in FIGS. 7 and 8 differs from the exemplary embodiment described above in that it has modified dimensional measures 14, which are also formed from belt pieces 15 and are arranged in a modified arrangement along the tracks 7, 8.

The dimensional measures 14 only bear position symbols 16, indicated in the exemplary embodiment by the numerically increasing sequence of numbers 1 to Lmax.

As in the previously described exemplary embodiment, belt pieces 14 of one track 7, 8 overlap the adjacent belt pieces 14 of the other track 7, 8. In an overlapping region y1, y2, y3, yn. Each overlapping region is unique in terms of the amount thereof and, in the exemplary embodiment, steadily increases from left to right. When the overlapping regions yn are driven over, the measuring heads 6 read in the detected values yn and can be assigned to a specific section of the guide rail 2 on the basis of the one-time allocation thereof. In connection with the detected position symbols 16, an exact position of the guide carriage 1 on the guide rail 2 can be determined accordingly.

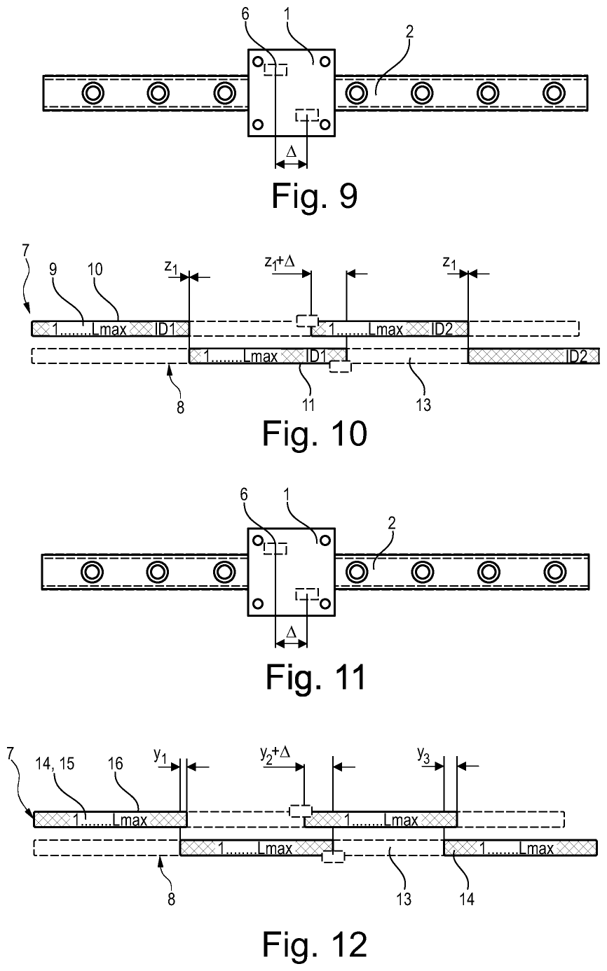

The exemplary embodiment shown in FIGS. 9 and 10 differs from the first exemplary embodiment in that it has a modified arrangement of the two measuring heads 6 on the guide carriage 1 and a modified overlapping region z1.

The two measuring heads 6 are axially offset from one another by an amount delta. Each belt piece 12 of one track 7, 8 overlaps two adjacent belt pieces 12 of the other track 7, 8: at one axial end by an overlapping region z1 and at the other axial end by an overlapping region z1+delta. When the guide rail 2 is driven over, the position of the guide carriage 1 on the guide rail 2 can thus be easily determined.

The exemplary embodiment shown in FIGS. 11 and 12 differs from the exemplary embodiment according to FIGS. 7 and 8 essentially in that it has a modified arrangement of the two measuring heads 6 on the guide carriage 1 and an adapted overlap of the belt pieces 12.

The two measuring heads 6 are arranged to be axially offset from one another by an amount delta. Each belt piece 12 of one track 7, 8 overlaps two adjacent belt pieces 12 of the other track 7, 8: at one axial end by an overlapping region yn and at the other axial end by an overlapping region yn+delta. As in the exemplary embodiment according to FIGS. 7 and 8, yn, the amount of which is constantly increasing, enables the position of the guide carriage 1 to be clearly assigned to a section on the guide rail 2. When the guide rail is driven over, the position of the guide carriage 1 on the guide rail 2 can thus be easily determined.

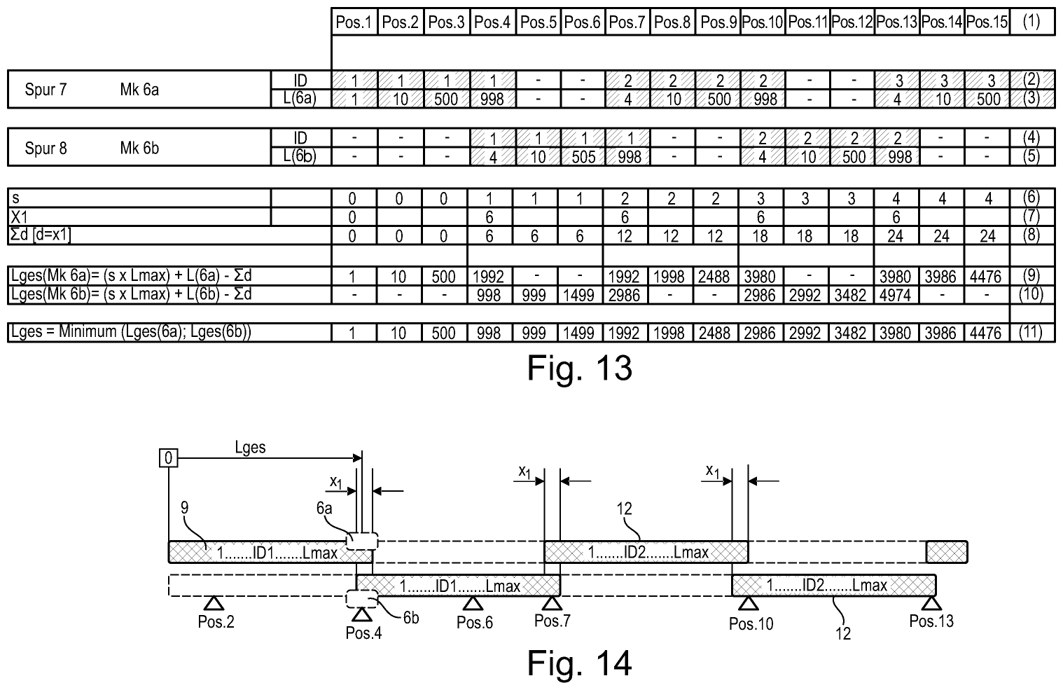

FIGS. 13 and 14 correspond to the exemplary embodiment shown in FIGS. 5 and 6. The sequence of position detection of the guide carriage 1 on the guide rail 2 will be described in detail with reference to FIGS. 13 and 14.

A distinction is made between the two measuring heads (6a) and (6b) for the exemplary calculation. In this example, a coded length Lmax of the individual belt of 1000 mm is assumed. In the table according to FIG. 13, the zero point of the dimensional measure is indicated as “0”. The table according to FIG. 13 continuously shows the respective position Pos. 1 to Pos. 15 of the measuring guide carriage. Selected positions are marked in FIG. 14.

The last column of the table according to FIG. 13 is numbered line by line.

Lines 2 and 3 reproduce the identifier 11 “ID” for the respective position along the track 7 and the length position L (6a) detected by the measuring head (6a) on the respective belt piece 12. Positions with measured values (e.g. Pos. 2) are indicated, each from 1-1000 mm. Fields without measured values indicate sections that have been driven over that do not have a belt piece 12.

Lines 4 and 5 show measured values for the track 8 in a corresponding manner.

Lines 6 to 8 contain data that are required to calculate the entire travel distance Lges: the number of joints s driven over at the respective position in relation to the zero point of the dimensional measure 9 and the other data:

Line 6 continuously shows the total number of joints “s” 12 of both tracks 7 and 8.

Regions of the belt pieces 12 of both tracks 7 and 8 that overlap one another are indicated by “X1” in line 7. In the exemplary embodiment, X1 is a constant value d=6 mm.

X1=Lmax−maximum (L6a; L6b)+minimum (L6a; L6b)

Example, Pos. 4: x1=Lmax−L(6a)+L(6b)=1000−998+4=6
Example, Pos. 17: x1=Lmax−L(6b)+L(6a)=1000−998+4=6

Line 8 now shows the cumulative offset Σd of the respective position, i.e., the cumulative overlapping regions d over the entire measuring length. In the present example, d=x1 and since x1 is constant, in this case Σd also corresponds to the number of joints s*x1. Depending on the design, these values must be recorded and saved via a “teach-in run” when the measuring arrangement is put into operation.

Line 9 and line 10 now show the total length Lges calculated for each measuring head (6a and 6b), which are calculated as follows:

Lges(6a)=(s×Lges)+L(6a)−Σd

Lges(6b)=(s×Lges)+L(6b)−Σd

The table also shows that there are differences in the values Lges (6a) and Lges (6b) in the region of the overlapping joints (Pos. 4, 7, 10, 13). This results from the rasterization of the calculation using the number of joints, s. The smaller of the two values is the correct length Lges to the zero point 0 of the rail line.

In line 11 Lges results in: Lges=minimum[Lges (6a); Lges (6b)].

### LIST OF REFERENCE SYMBOLS

1 Guide carriage
2 Guide rail
3 Leg
4 Back
5 Length measuring device
6 Measuring head
7 Track
8 Track
9 Dimensional measure
10 Position symbols
11 Identifier
12 Belt piece
13 Filler piece
14 Dimensional measure
15 Belt piece
16 Position symbols

What is claimed is:

1. A linear guide, comprising:
a guide carriage arranged to be longitudinally displaceable on a guide rail, and the guide carriage having a length measuring device configured for determining a position of the guide carriage on the guide rail, the length measuring device having two measuring heads and two tracks arranged side-by-side on the guide rail, each of the two tracks being assigned to one of the two measuring heads, the two tracks each having a plurality of dimensional measures arranged one behind the other along the respective track, the dimensional measures of the two tracks overlapping one another in an overlapping region.

2. The linear guide according to claim 1, wherein the overlapping region (z1) of which is larger than a signal detection width of at least one of the two measuring heads.

3. The linear guide according to claim 1, wherein the measuring heads are arranged at a same height in a direction of an axis of the guide rail.

4. The linear guide according to claim 1, wherein the two measuring heads have an axial offset to one another in a direction an axis of the guide rail.

5. The linear guide according to claim 1, wherein the dimensional measures each bear a unique identifier which is different from the respective identifier of each of the other dimensional measures.

6. The linear guide according to claim 1, wherein the dimensional measures of the two tracks overlap one another in a plurality of overlapping regions, each of the overlapping regions being of a different size from all other of the overlapping regions.

7. The linear guide according to claim 1, wherein the dimensional measures along one of the two tracks and are arranged axially spaced apart from one another with an axial offset, and filler pieces are inserted between the dimensional measures which are arranged side-by-side.

8. The linear guide according claim 1, wherein the guide carriage surrounds the guide rail with two legs, wherein the guide rail is provided with the two tracks on at least one of two longitudinal sides thereof.

9. The linear guide according to claim 8, wherein a first of the two tracks is arranged on a first of the two longitudinal sides and a second of the two tracks is arranged on a second of the two longitudinal sides, the second longitudinal side being opposite of the first longitudinal side.

10. A linear guide comprising:
a guide rail;
a guide carriage arranged to be longitudinally displaceable on the guide rail; and
a length measuring device configured for determining a position of the guide carriage on the guide rail, the length measuring device including a first track including first dimensional measures arranged one behind another and a second track including second dimensional measures arranged one behind another, the first track and the second track being arranged side-by-side on the guide rail,
the length measuring device further including a first measuring head on the guide carriage arranged and configured for scanning the first track and a second measuring head on the guide carriage arranged and configured for scanning the second track,
each of the first dimensional measures overlapping at least one of the second dimensional measures in a plurality of overlapping regions.

11. The linear guide according to claim 10, wherein each of the overlapping regions are larger than a signal detection width of the first measuring head and larger than a signal detection width of the second measuring head.

12. The linear guide according to claim 10, wherein each of the first dimensional measures and each of the second dimensional measures include a unique identifier which is different from the respective identifier of each of the other first and second dimensional measures.

13. The linear guide according to claim 10, wherein each of the overlapping regions is of a different size than each of the other overlapping regions.

14. The linear guide according to claim 10, wherein the first dimensional measures are each axially spaced apart from each other by first filler pieces and the second dimensional measures are each axially spaced apart from each other by second filler pieces.

15. The linear guide according to claim 10, wherein the overlapping regions are of increasing length in an axial direction.

16. The linear guide according to claim 10, wherein the first and second dimensional measures each include a scale indicating a position on the respective first and second dimensional measures.

17. The linear guide according to claim 10, wherein the length measuring device is configured for determining the position of the guide carriage on the guide rail based on a smaller of a value calculated for the first measuring head and a value calculated for the second measuring head.

18. A method of creating a linear guide comprising:
providing a guide carriage and a guide rail;
providing a length measuring device configured for determining a position of the guide carriage on the guide rail by:
providing a first measuring head and a second measuring head on the guide carriage, and
providing a first track and a second track side-by-side on the guide rail, the first rack including first dimensional measures and the second track including second dimensional measures, the first dimensional measures overlapping the second dimensional measures in an overlapping region; and
arranging the guide carriage longitudinally displaceable on the guide rail such that the first measuring head is arranged and configured for scanning the first track and the second measuring head is arranged and configured for scanning the second track.
